(19) United States
(12) Patent Application Publication
(10) Pub. No.: US 2004/0087467 A1
(43) Pub. Date: May 6, 2004

(54) Edible dissolving gelatin strips

(76) Inventor: Reg MacQuarrie, Toronto (CA)

Correspondence Address: Randall S. Mitchell, c/o Ridout & Maybee LLP, Suite 2400, One Queen Street East, Toronto, ON, M5C 3B1, CA

(21) Appl. No.: 10/695,905

(22) Filed: Oct. 30, 2003

Related U.S. Application Data
(60) Provisional application No. 60/422,123, filed on Oct. 30, 2002.

(51) Int. Cl. C11D 17/00

(52) U.S. Cl. 510/438

(57) ABSTRACT

Orally disintegrating or dissolving edible strips for use as a matrix for retaining and delivering nutrients, flavors and medicinal compounds are made from new liquid film casting compositions comprising a major proportion of gelatin. The particularly low melting range for hydrated gelatin produces films that leave virtually no residue upon dissolving in the mouth and can be used in the form of thicker films and strips than known edible films.

### RELATED APPLICATION

This application claims priority based on U.S. provisional patent application No. 60/422,123 filed on Oct. 30, 2002, which is incorporated herein by reference.

### BACKGROUND OF THE INVENTION

Orally disintegrating or dissolving edible materials are currently used in a large variety of applications as a matrix for conveniently holding and using nutrients, flavors and medicinal compounds such as breath fresheners. The slow-dissolving edible strips currently in use are typically produced from pullulan, sodium alginate, starches, carrageenans or combinations of these ingredients. All of these are suitable film forming materials which dissolve adequately, but they tend to leave an undesirable gummy residue in the mouth that remains for a greater or lesser period of time after the film structure has broken down and the matrix has released its contents.

I have found that gelatin, widely used in a number of candy applications, is unusually suitable as the major film component of edible film materials, for use as edible dissolving strips.

Gelatin, in particular high bloom gelatin, is an excellent film former and can readily be cast into film form. Unique among the hydrocolloids, gelatin melts at approximately 37° C., with the result that an edible strip composed primarily of gelatin dissolves and melts in the mouth without leaving any of the unpleasant residue associated with polysaccharide films. A consequence of the unique melting property of gelatin is that films can be made thicker than films composed of other materials used for this purpose. Typical polysaccharide films in edible dissolving strips are less than 35 microns in thickness, whereas gelatin-based films can be used for this purpose with thicknesses as great as 85 microns. The thicker films do tend to dissolve more slowly, but still melt into their gelatin content, resulting in a pleasant sensation in the mouth.

### DESCRIPTION OF THE INVENTION

The present invention is directed to edible dissolving film of a material comprising gelatin in combination with lesser proportions of plasticizers and selected flavors, medicinal compounds or nutrients, as desired.

To prepare films according to the present invention, gelatin and the other ingredients are dissolved in water under high shear. If hot-water gelatin is employed, then the polymers must be dissolved at elevated temperatures to ensure that the gelatin will hydrate property. As the polymers become fully hydrated, additional additives can be introduced including plasticizers, flavors, various salts, medicinal compounds and colors. Where necessary, the gelatin in solution can be cooled down to ambient temperatures prior to the addition of volatile flavors or organic materials, to reduce the amount of potential “flash off” and consequent diminishment of flavor in the solution.

As the solution is cooled, its viscosity increases and it becomes easier to cast onto a steel belt or plastic web as required. Typically, the hot solution is cast onto the web by the use either of a box or conventional closed die. On the web this solution is dried to the desired moisture level for stability and the dried film is then removed from the web on the plastic vacuum, to be cut into strips for consumption.

The film can also be produced using standard film extrusion techniques employing either a single-screw or twin screw extruder.

It is expected that most products made up of films according to the present invention will be strips, but using known film extrusion techniques films according to the present invention can be extruded into tubular or other shapes. The film can also be formed into bags by sealing edges together. Such bags or pouches might be used to contain other sweeteners, flavored powders or solutions. For example, a small bag produced from edible film according to the invention encapsulating liquid flavoring dissolved in an edible oil or propylene glycol will dissolve in the mouth, releasing the liquid flavoring as a “secondary” flavor sensation for the consumer.

The gelatin film forming base can be augmented with smaller amounts of other polymers to modify the characteristics of the final film to meet the demands of particular applications. However, the proportion of other polymers that can be added should be kept low to minimize any left over residue following dissolution of the film structure.

Suitable polymers for addition to the gelatin in producing edible dissolving strips according to the present invention include starch (tapioca), low molecular weight corn and potato starches, alginates, lambda carrageenans, and various other polysaccharides. For optimum solubility of the film, the composition should be such that the gelatin component makes up at least 50% by weight of the total composition.

Some variation in properties for different applications can be achieved by using gelatins having a variety of bloom strengths (gel strengths) and different provenance, including bovine, porcine and fish gelatins. The use of cold-water soluble gelatin aids in production of the film by obviating the necessity of heating the solution.

The film can be also sweetened with traditional sweeteners including sucralose, aspartame, ascuefame K and other artificial sweeteners.

The film may advantageously be plasticized by the addition of a polyol such as sorbital or other sugar alcohols. Glycerine or propylene glycol may also be used.

Gelatin-based films according to the present invention can be easily flavored with all manner of natural and artificial flavors including menthols and other cooling agents. The loads on such flavorings can be adjusted as required. The total load of oil-based flavors can range as high as 25% of the total composition but are normally optimized below 15% of the total composition based on weight.

### EXAMPLES

Examples 1 to 3 below illustrate specific compositions within the present invention.

| | % |
|---|---|
| Example 1 | |
| Gelatin 100 bloom | 76 |
| Sorbitol | 3 |
| Water | 6 |
| Flavor-L-menthol | 10 |
| Peppermint | 3 |
| Mono and diglycerides | 2 |
| Example 2 | |
| Gelatin 250 bloom | 81 |
| Sorbitol | 3 |
| Water | 8 |
| Polysorbate 80 | 3 |
| Flavor - Mango | 5 |
| Example 3 | |
| Gelatin (250 bloom) | 82 |
| Sweetener (Sucralose) | 0.80 |
| Sorbitol | 4 |
| Glycerin | 7.0 |
| Sorbitan ester | 1.5 |
| Color | .02 |
| Water | 4.6 |

Although specific film compositions have been given as examples of materials within the present invention, it will be understood that it is the novel inclusion of a major portion of gelatin in edible film forming materials that affords unique advantages over the film-forming materials conventionally used to make edible matrices in strips and other forms. No unnecessary limitations should be understood from the examples given, as modifications will be obvious to those of skill in the art without departure from the scope and spirit of the appended claims.

I claim:

1. A liquid composition for casting into an edible film, comprising at least 50% by weight of gelatin, selected flavoring materials, an edible polyol plasticizer and sufficient water to dissolve the other components of the composition.

2. A liquid composition according to claim 1, further comprising an artificial sweetener.

3. A liquid composition according to claim 2, wherein said gelatin is a high bloom gelatin.

4. A liquid composition according to claim 2, further comprising an edible polymer selected from the group consisting of tapioca starch, low molecular weight corn starch, low molecular weight potato starch, alginates and lambda carrageenans.

5. A liquid composition according to claim 2, wherein said plasticizing polyol is glycerine.

6. A liquid composition according to claim 2, wherein said plasticizing polyol is propylene glycol.

7. A liquid composition according to claim 1, wherein said flavoring materials are artificial oils making up less than 15% by weight of the total composition.

8. An edible, orally dissolving film prepared by solution casting or extrusion of a liquid composition according to claim 2.

9. A film according to claim 7, having a thickness between 35 microns and 85 microns.
